(19) United States
(12) Patent Application Publication
(10) Pub. No.: US 2025/0316061 A1
(43) Pub. Date: Oct. 9, 2025

(54) METHOD FOR TRAINING A MACHINE LEARNING MODEL FOR DISCOVERING OBJECTS IN AN IMAGE SEQUENCE

(71) Applicant: COMMISSARIAT À L'ENERGIE ATOMIQUE ET AUX ENERGIES ALTERNATIVES, PARIS (FR)

(72) Inventors: Sandra KARA, GIF SUR YVETTE (FR); Hejer AMMAR, GIF SUR YVETTE (FR); Florian CHABOT, GIF SUR YVETTE (FR); Quoc-Cuong PHAM, GIF SUR YVETTE (FR); Julien DENIZE, GIF SUR YVETTE (FR)

(21) Appl. No.: 19/087,467

(22) Filed: Mar. 22, 2025

(30) Foreign Application Priority Data
Apr. 8, 2024 (FR) 2403608

(51) Int. Cl. G06V 10/774; G06V 10/74; G06V 10/776; G06V 10/778; G06V 20/40

(52) U.S. Cl. CPC G06V 10/774; G06V 10/761; G06V 10/776; G06V 10/7792; G06V 20/41

(57) ABSTRACT

A method for training a model for discovering objects in an input image sequence, the model includes an encoder; an attention module configured to transform the first feature vector into a plurality of feature vectors, called slots; a decoder; the learning of the attention maps being monitored by a set of binary masks for discovering mobile objects produced by an external source, called pseudo-labels; the pseudo-labels being filtered by means of the following steps of: determining an attention map of the foreground of the image; computing a confidence score from the average of the values of the attention map of the foreground of the image at the positions of each mobile object present in a pseudo-label; filtering the mobile objects of the pseudo-labels for which the confidence score is below a predefined threshold.

### CROSS-REFERENCE TO RELATED APPLICATION

This application claims priority to foreign French patent application No. FR 2403608, filed on Apr. 8, 2024, the disclosure of which is incorporated by reference in its entirety.

### FIELD OF THE INVENTION

The invention relates to the field of discovering objects in an image sequence. It is a computer vision task that aims to localise the objects present in an image by producing object masks for each localised object. An object mask is a binary image comprising values of ‘1’ at the locations of the pixels of the object and values of ‘0’ elsewhere. There are as many masks as there are objects present in the scene captured by the image sequence.

The invention relates to a new method for discovering objects involving implementing a particular machine learning model. The invention notably relates to training this model in order to carry out a task of discovering objects from a given image sequence.

### BACKGROUND

The invention is applicable in various fields that require localisation of objects in an image sequence, in particular, but not exclusively: vision systems for autonomous driving, exploration of unknown environments, video surveillance systems, segmentation of active cells in medical data or even self-learning vision systems.

A general problem to be addressed in the field of discovering objects involves carrying out this task in an unmonitored manner, unlike the task of detecting objects, which requires annotated learning data. An advantage associated with unmonitored training lies in the savings made in relation to the acquisition of labelled data, which is most often carried out by an operator.

However, the absence of annotated data conversely makes it more difficult to complete the learning. One of the challenges encountered in terms of the unmonitored discovery of objects is the lack of a clear definition of what constitutes an object.

References [1] and [2] describe methods for discovering objects that aim to localise objects characterised by their motion. In other words, these methods are oriented towards discovering mobile objects.

The methods described in references [1] and [2] propose replacing the human annotation of learning data with the use of the motion information of objects within the image sequence.

The advantage of selecting motion information is that this information can be estimated automatically and without human intervention (monitoring). These approaches propose a model for discovering objects integrated in a pipeline made up of two main phases.

FIG. 1a illustrates the first phase, which involves learning to generate a set of binary object masks MO from images SI and associated optical flow maps FO. This task is carried out using a machine learning model IA. The optical flow map corresponds to a motion map in which the pixel values describe the motion of mobile objects between two consecutive images. The model IA is trained using synthetic data, without requiring human annotations.

FIG. 1b illustrates the second phase, which involves applying the trained model IA to real data SI′ accompanied by an optical flow map FO′ in order to generate object masks MO′ that correspond to pseudo-labels because they may be noisy and/or incomplete. The noise can originate from the imperfection of the motion map and is mainly expressed by the presence of random segments occupying the background of the image. Furthermore, the incomplete nature is related to the very use of motion information, resulting in the absence of static objects in these pseudo-labels.

Another model MGOD is then trained to discover objects DO from the image sequence SI′ and pseudo-labels MO′. The approach described in reference [3] is based on an architecture that implements an attention mechanism applied to slots. Each slot is associated with an attention map and the learning of the model forces the regions of the input image to be shared between several attention maps whose values vary between 0 and 1. Each attention map activates a specific region (the pixel values of this region are then close to 1) and attenuates the rest of the image (pixels close to 0). It is then said that the attention of the model is oriented towards this activated region.

The model MGOD is trained by integrating the pseudo-labels of mobile objects MO′ into the learning architecture as follows: some maps from among the K attention maps are monitored (by an appropriate loss function) to contain the mobile segments, while the other attention maps are left free without monitoring. The behaviour of the observed model is such that mobile objects appear on the monitored maps, and either static objects that are visually similar to them or random segments (noise) appear on the unmonitored maps.

The method described in FIGS. 1a and 1b notably has two limitations.

A first problem is the lack of distinction between the random segments corresponding to noise and the useful segments corresponding to objects. This results from the lack of monitoring of the training for discovering objects. Thus, these methods are not very noise resistant, particularly that caused by camera motion.

A second problem is that this method mainly uses motion information, which significantly limits the localisation of static objects in the sequence. The ‘mobile object to static object’ extension offered by the “slot-attention” architecture notably proposed in reference [2] works by redirecting the attention of the model to objects that resemble those already known to be moving. Nevertheless, this method has its limitations. It does not guarantee that the model will detect a sufficient amount of static objects, or even that it will detect them reliably. The detection entirely depends on the ability of the model to judge whether a new static object sufficiently resembles the mobile objects it already knows.

Reference [4] addresses the first aforementioned problem in a more recent approach, proposing a noise management component in the background of the image. This component involves learning the separation between, on the one hand, all the objects in the scene that are activated in a map dedicated to the foreground of the image and denoted W_{fg}, and, on the other hand, the background of the image that does not contain objects of interest (i.e. objects capable of moving). This background is activated in a map denoted W_{bg} from among the K attention maps. By placing the background in this map, and since all the attention maps complement each other, this prevents random segments from appearing in the other K−1 maps dedicated to objects.

However, this approach only allows partial management of the noise in the background of the image. Indeed, the noise that appears in the background of the image, among the outputs of the model, has mainly two causes: the first cause is related to the “slot-attention” architecture, and to the fact that the free attention maps can pick up noise, and the second cause is related to the input pseudo-labels, which, if noisy, propagate this noise to the outputs of the model. The approach of article [4] addresses the first cause by introducing an additional constraint that prevents the empty attention maps from picking up noise. However, the second cause of this problem is not addressed.

### SUMMARY OF THE INVENTION

The invention aims to overcome the limitations of the prior art by means of a method that provides a solution to the two problems discussed above.

The invention proposes introducing automatic and reliable filtering of the noise segments contained in the pseudo-labels at the input of the model based on a confidence score computation.

The invention also proposes introducing a distillation-based learning approach in order to integrate static objects into the monitoring of the attention maps of the model. Thus, even when the pseudo-labels are derived from motion and therefore do not contain static objects, they are supplemented by introducing a second monitoring source in the form of a master model and via distillation-based learning. The result of this component is much better localisation of objects, notably static objects.

The proposed method for discovering objects in an image sequence is capable of filtering the input pseudo-labels derived from motion and of automatically improving through training, by reintegrating its own results.

The invention allows a technical obstacle to be addressed that is related to the noise present in the inputs of models for discovering objects of the prior art.

In particular, in distillation-based training architectures, noise can be propagated in both the master and student models. In this type of scenario, the success or failure of the distillation depends on the amount of noise that is present: if the noise segments are in the minority among the input pseudo-labels, the model is able to ignore them. This condition is not necessarily verified in real applications where the noise can reach significant levels, resulting in the failure of the distillation.

Moreover, this technical obstacle is more pronounced when the basic model is based on the ‘slot attention’ architecture. Indeed, this architecture is particularly interesting for the aforementioned methods of the prior art because it allows attention to be extended to static objects, which are absent in the motion information. However, the ‘slot attention’ architecture also amplifies the input noise. Indeed, the same mechanism that allows the ‘mobile objects to static objects’ extension is responsible for amplifying the noise received as input. For example, the model can generate, on the free attention maps, other random segments similar to the input noise. This noise therefore becomes critical and inhibits the development of the distillation applied to discovering objects using a ‘slot attention’ mechanism.

The aim of the invention is a computer-implemented method for training a machine model for discovering objects in an input image sequence, the model comprising:
an encoder for encoding each image into a first feature vector;
an attention module configured to transform the first feature vector into a plurality of feature vectors, called slots, with the state of a slot being determined from a similarity computation between the first feature vector and each slot in its current state, with each similarity computation defining an attention map;
a decoder for decoding all the slots in order to reconstruct an image sequence corresponding to the input image sequence;
the learning of the attention maps being monitored by a set of binary masks for discovering mobile objects produced by an external source, called pseudo-labels, such that each attention map is activated in a zone corresponding to a distinct object contained in the pseudo-labels, an additional attention map is activated in a zone corresponding to the background of the image;
the pseudo-labels being filtered by means of the following steps of:
   i. determining an attention map of the foreground of the image;
   ii. computing a confidence score from the average of the values of the attention map of the foreground of the image at the positions of each mobile object present in a pseudo-label;
   iii. filtering the mobile objects of the pseudo-labels for which the confidence score is below a predefined threshold.

According to a particular aspect of the invention, the attention map of the foreground of the image is determined from the attention map of the background of the image of the attention module of the model.

According to a particular aspect of the invention, said model is a student model at least partially trained via a distillation-based learning transfer mechanism from a master model, with the master model comprising an encoder and an attention module, with the attention map of the foreground of the image of the student model being determined from the attention map of the background of the image of the attention module of the master model.

According to a particular aspect of the invention, the learning of the attention maps of the student model is monitored by the attention maps of the master model so that each attention map is activated in a zone corresponding to a distinct object discovered in the attention maps of the master model.

According to a particular aspect of the invention, the learning of the attention maps of the student model comprises the following steps of:
binarising each attention map of the master model;
determining all the connected regions in all the binarised attention maps, with each connected region corresponding to a distinct discovered object.

According to a particular aspect of the invention, the learning of the attention maps of the student model further comprises the following steps of:
computing a confidence score for each discovered distinct object as being equal to the average value of the activations of said object in each attention map of the master model;
filtering the objects for which the confidence score is below a predetermined threshold.

According to a particular aspect of the invention, the monitoring of the attention maps of the student model is at least carried out by means of a first cross-entropy loss function applied between the attention maps of the student model and the objects determined from the attention maps of the master model weighted by their confidence score.

According to a particular aspect of the invention, the monitoring of the attention maps of the model is at least carried out by means of a second cross-entropy loss function applied between the attention maps of the model and the objects of the pseudo-labels weighted by their confidence score.

According to a particular aspect of the invention, the pseudo-labels are obtained from the image sequence and an associated optical flow sequence.

A further aim of the invention is a computer-implemented method for discovering objects in an image sequence comprising the following steps of:
receiving an image sequence;
executing the machine model for discovering objects trained using the method according to the invention for the image sequence so as to generate at least one localisation mask for an object in the image sequence, with each localisation mask being obtained from an attention map.

A further aim of the invention is a computer program comprising instructions for executing the method according to the invention, when the program is executed by a processor.

A further aim of the invention is a processor-readable storage medium storing a program comprising instructions for executing the method according to the invention, when the program is executed by a processor.

### BRIEF DESCRIPTION OF THE DRAWINGS

Further features and advantages of the present invention will become more clearly apparent from reading the following description with reference to the following appended drawings, in which:

FIG. 1a shows a diagram illustrating a method for machine learning object masks from motion information according to the prior art;

FIG. 1b shows a diagram illustrating a method for machine learning for discovering objects from object masks obtained via the method of FIG. 1a;

FIG. 2 shows a diagram illustrating the implementation of a method for machine learning for discovering objects according to a first embodiment of the invention;

FIG. 3 shows a diagram illustrating a step of filtering pseudo-labels in the method of FIG. 2;

FIG. 4 shows a flowchart describing the implementation of the filtering step;

FIG. 5 shows a diagram illustrating the implementation of a method for machine learning for discovering objects according to a second embodiment of the invention;

FIG. 6 shows a diagram illustrating the implementation of a method for machine learning for discovering objects according to a third embodiment of the invention;

FIG. 7 shows a flowchart describing the implementation of a step of monitoring a student model by a master model, according to the third embodiment of the invention.

### DETAILED DESCRIPTION

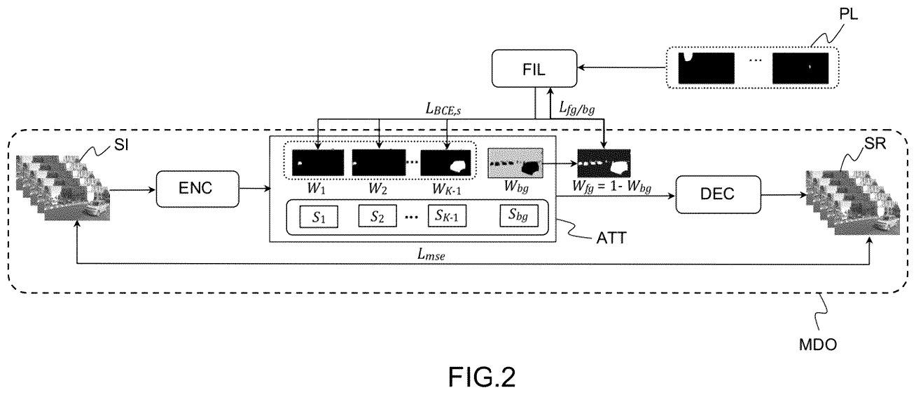

FIG. 2 shows a diagram of the method for training a machine learning model for discovering objects according to a first embodiment of the invention.

This first embodiment aims to address the specific problem of the presence of noise in the pseudo-labels used for learning.

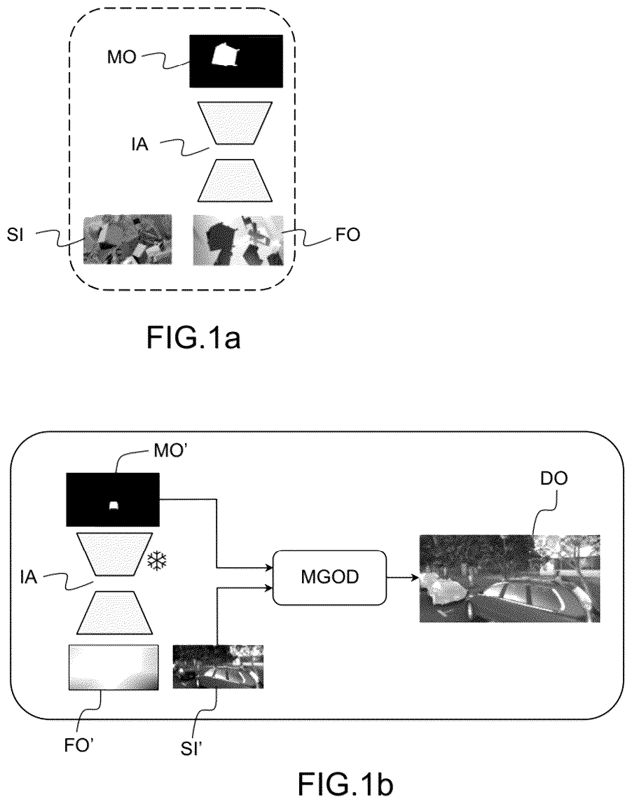

To this end, the model MDO receives as input an image sequence SI and a set of pseudo-labels PL that correspond to binary object masks that are obtained, for example, using the method described in FIG. 1a. These masks are imperfect due to the presence of noise. They are intended to label the mobile objects in the scene.

Without departing from the scope of the invention, the pseudo-labels PL can be obtained by other methods, for example human annotations or via other types of object discovery algorithms.

Each pseudo-label is intended to correspond to a mobile object present in the image sequence SI. For the aforementioned reasons, some masks can correspond to noise and not to objects.

The basic model MDO that is used corresponds to that described in references [1], [2] and [3], which is based on a “slot attention” type architecture. More specifically, this model includes an encoder ENC configured to encode each image in a latent representation space so as to generate a vector of spatio-temporal features describing the content of the sequence. The encoder ENC is, for example, an artificial neural network, such as a residual neural network, or any other machine learning model capable of encoding an image sequence into a set of spatio-temporal features.

The model MDO also includes an attention module ATT that aims to transform a set of N spatio-temporal features obtained at the output of the encoder ENC into K vectors, called “slots”, the dimension of which is a hyper-parameter of the architecture. The attention module ATT is trained so that each slot describes an object or, more generally, a zone of interest that is different from the image sequence.

The attention module ATT implements an iterative attention mechanism that aims to learn a function for transforming or mapping the N features to K slots; the coefficients of this function can be represented in the form of an attention map, the normalised values of which vary between 0 and 1. Each attention map activates a different zone of the image.

FIG. 2 shows K−1 slots S₁, . . . S_{K-1} associated with K−1 objects in the scene and an additional slot S_{bg} corresponding to the background of the scene. Each slot is associated with an attention map W₁, . . . W_{K-1}, W_{bg}. The iterative attention mechanism aimed at training the attention module ATT is described in further detail in reference [3].

The slots S₁, . . . S_{K-1}, S_{bg} obtained in the final iteration are then supplied to a decoder DEC, which carries out a slot decoding operation to reconstruct an image sequence SR. The decoder DEC is, for example, a convolutional neural network.

The model MDO is trained so as to minimise a loss function L_{MSE} based on a distance or error criterion between the reconstructed sequence SR and the input sequence SI.

In addition, pseudo-labels PL are used to monitor some maps from among the K−1 attention maps W₁, . . . W_{K-1} so that each attention map is oriented towards a different object from among the set of object masks that form the pseudo-labels. This principle, introduced in references [1] and [2], involves monitoring the training of the model using an external source characterising the motion in the scene, i.e. the mobile objects. The maps to be monitored are selected via a matching algorithm between the pseudo-labels and the content of the attention maps. This process is described in further detail in reference [1] and aims to orient each monitored attention map towards a different object from among all the object masks that form the pseudo-labels.

Thus, the attention module ATT is trained to generate K−1 attention maps that are oriented towards distinct objects and an attention map oriented towards the background of the image. An object localisation mask can be derived from each attention map obtained for an object by binarising the activation values of the map.

The invention aims to further improve the monitored training of the model MDO by adding a function for filtering FIL pseudo-labels and associating a confidence score with each object identified in the pseudo-labels in the monitoring of the attention maps.

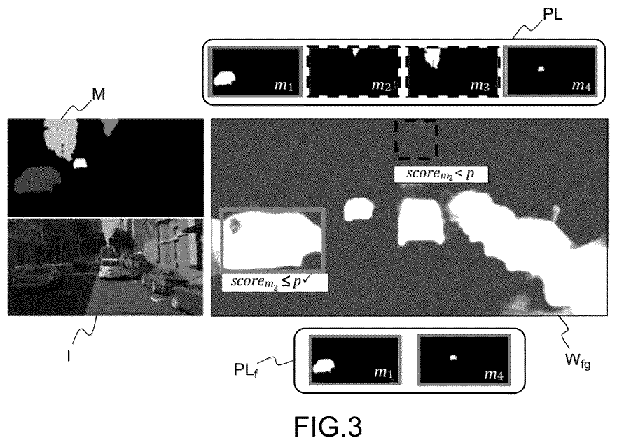

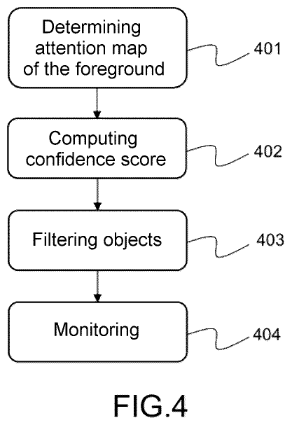

FIGS. 3 and 4 illustrate the implementation of this filtering function FIL, which comprises several successive steps.

In step 401, an attention map W_{fg} of the foreground of the image is initially determined from the attention map W_{bg} of the background of the image as the negative thereof: W_{fg}=1−W_{bg}. The attention map of the foreground theoretically contains all the objects present in the image, unlike the attention map of the background, which only contains the background of the image.

An example of an attention map W_{fg} of the foreground is provided in FIG. 3 for an image I.

FIG. 3 also shows an example of pseudo-labels PL comprising four binary object masks m₁, m₂, m₃, m₄. As the pseudo-labels are in binary form, they do not allow an object to be distinguished from a noise segment.

In step 402 of the method, a confidence score is then computed for each of the masks based on the attention map W_{fg} of the foreground of the image, which is made up of non-binary values, which typically vary between 0 and 1, and which reflects the semantic content of the image. In other words, the objects identified in the pseudo-labels originating from an external source are found in the attention map W_{fg}, which is intended to contain a representation of all the objects in the scene.

For each mask mᵢ, with i varying from 1 to M and M being the number of pseudo-labels, the confidence score is computed as being the average of the activations of the attention map W_{fg} at the spatial positions of the map corresponding to the spatial positions of the mask for which the mask assumes a value of 1.

The confidence score can be represented by the following formula:

$${score}_{mi} = \frac{1}{{\sum }_{j = 1}^{N} {m}_{i} ( j )} {\sum }_{j = 1}^{N} {W}_{fg} ( j ) ⊙ {m}_{i} ( j ) ,$$

where ⊙ denotes the term-by-term product operator of two matrices.

The index j varies from 1 to the number of pixels N in the activation map W_{fg}, which has the same dimensions as each object mask mᵢ.

The confidence score can be computed for each object because the attention map W_{fg} contains activations for all the pixels in the scene, since this map is computed from the scene received as input.

In step 403, the computed confidence score is compared to a predefined threshold p, the value of which is considered to be close to 1 in order to effectively filter the least reliable predictions, for example to a value of 0.9. The masks for which the confidence score is below this threshold are removed from all the pseudo-labels, as illustrated in the example in FIG. 3. In this example, the masks m₂ and m₃ are removed because their confidence score is below the threshold p and they are more likely to correspond to a noise segment.

Indeed, the attention map W_{fg} should normally have high activation values for the zones of the image corresponding to objects. By comparing the average activation value of the zones of the attention map W_{fg} corresponding to the objects identified in the pseudo-labels PL to a threshold, it is possible to eliminate objects that have low activation values, which signifies the presence of noise.

The masks for which the confidence score is greater than or equal to the threshold p are, however, used to monitor, in step 404, the training of the attention module ATT by means of a loss function that aims to associate some attention maps from among the K−1 attention maps W₁, . . . W_{K-1} with one of the mobile objects present in the pseudo-labels after filtering.

For example, a binary cross-entropy loss function is used such that:

$${L}_{BCE} ( {m}^{′} , W ) = - \frac{1}{N} {\sum }_{j = 1}^{N} [ ( 1 + {score}_{{m}^{′}} ) {m}^{′} ( j ) log ( W ( j ) ) + ( 1 - {m}^{′} ( j ) ) log ( 1 - W ( i ) ) ] ,$$

where m′ designates an object mask retained after filtering and W designates one of the K−1 attention maps. In other words, each filtered object mask m′ is used to monitor one of the attention maps W of the attention module. Other loss functions can be contemplated without departing from the scope of the invention.

The score of the filtered masks is taken into account when computing the loss function so as to give greater weight to objects with higher confidence.

Thus, filtering the noise in the pseudo-labels allows the model to be rendered more noise resistant by effectively eliminating irrelevant segments in the model outputs.

Eliminating noise segments also allows a distillation mechanism to be applied for discovering objects based on a “slot attention” type model.

The attention map of the foreground can be determined by monitoring using a binary cross-entropy loss function of the following type:

$${L}_{fg / bg} ( {{m}^{′}}_{fg} , {W}_{fg} ) = \frac{1}{N} {\sum }_{j = 1}^{N} [ - {{m}^{′}}_{fg} ( j ) log ( {W}_{fg} ( j ) ) + α {W}_{fg} ( j ) ] ,$$

where m′_{fg} is the sum of all the masks of objects m′ after filtering; and

α is a regularisation coefficient.

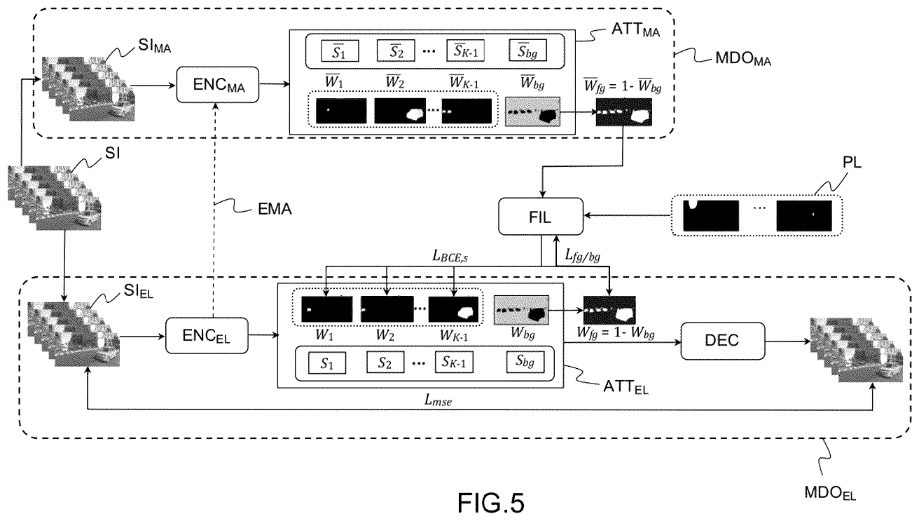

To this end, a second embodiment of the invention is illustrated in FIG. 5.

In this second embodiment, a distillation-based learning transfer mechanism is implemented based on a general principle that is notably described in reference [5].

The distillation process involves using two models with the same architecture: a master model MDO_{MA} and a student model MDO_{EL}. Each of the two models thus comprises an encoder ENC_{EL}, ENC_{MA} and an attention module ATT_{EL}, ATT_{MA} as described above. Only the decoder DEC of the student model is used in the distillation-based learning process. The master model comprises a similar decoder but it does not participate in any function or step during learning.

Each of the two models receives a different transformed version of the image sequence as input in order to prevent them from producing the same results, resulting in a self-confirmation bias. The transformations applied to the image sequence SI are, for example: transformations of the intensities (colours) or geometric transformations, such as an operation for cropping or zooming. The geometric transformations are also applied to the pseudo-labels PL in the same manner. In general, and as is known from the distillation principle, the transformations applied to the master model are of lower intensity and/or are fewer in number than those applied to the student model because it is preferable for the master model to have an input that is closer to the original than the student model. For example, the same geometric transformations are applied to the two models and to the pseudo-labels PL; however, the visual transformations on the intensities are only applied to the inputs of the student model.

The weights of the student model are updated by a gradient backpropagation mechanism so as to reconstruct the sequence received as input for the student model SI_{EL}, as described above for the first embodiment. However, the weights of the master model are computed as the moving average of the weights of the student model. The master model thus becomes a more stable version of the student model and produces more reliable results that are used to monitor the student model.

As described in reference [5], the distillation mechanism involves transferring or distilling the knowledge from the master model to the student model. The type of monitoring depends on the processed task. In the case of monitored detection of objects, the monitoring involves aligning the outputs of the student model with the most reliable predictions of the master model. In this case, an external data set is used to monitor the student model in order to prevent divergence of the master-student system. The distillation can be preceded by a preparation phase, called “burn-in”, during which the model is trained from external labels before being duplicated into a master model and a student model. The advantage of this preparation phase is that it provides initialisation that helps the two models to tend towards a better solution.

In the case of the invention, the predictions of the master model MDO_{MA} are attention maps denoted W̅₁, . . . , W̅_{K-1}, W̅_{bg}.

In the second embodiment of the invention, described in FIG. 5, the attention map of the foreground W̅_{fg}=1−W̅_{bg} of the master model MDO_{MA} is used to carry out the operation for filtering FIL the pseudo-labels.

An advantage of this embodiment lies in the benefit of the distillation mechanism using the attention map of the foreground learnt by the master model, which is more accurate than that of the student model.

The filtering FIL method described in FIG. 4 remains the same.

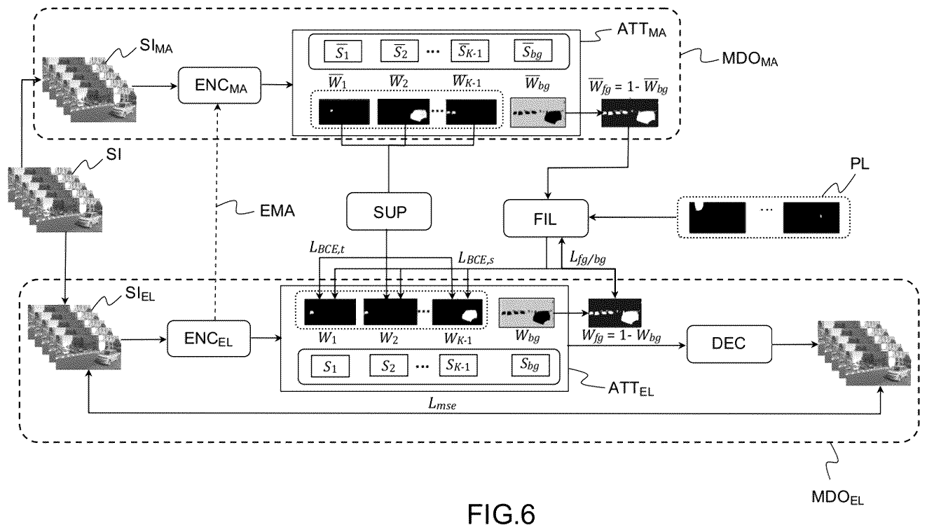

FIG. 6 shows a third embodiment of the invention, further comprising a monitoring module SUP for connecting the respective attention modules ATT_{EL}, ATT_{MA} of the two models MDO_{EL}, MDO_{MA}.

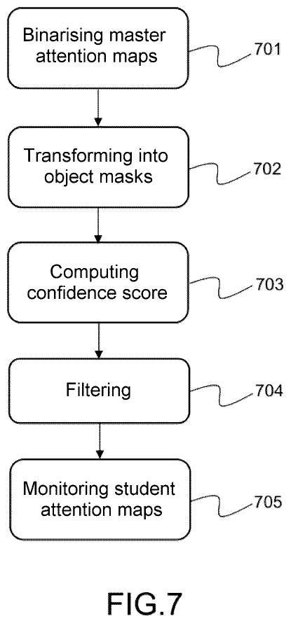

The monitoring module SUP implements the steps of the monitoring method described in FIG. 7.

In step 701, the attention maps W̅₁, . . . , W̅_{K-1} of the master model are transformed into binary maps, for example using the argmax operator. The values of each attention map that correspond to local maxima are set to 1, while the other values are set to 0. This results in K−1 binary masks.

Each of these masks can contain several connected regions, i.e. sets of adjacent pixels with a value of 1. In step 702, each connected region is considered to be corresponding to a separate object. When a mask comprises several objects, they are separated into as many distinct masks. Thus, the K−1 binary masks are transformed into C object masks, where C corresponds to the number of distinct objects.

The resulting set is then filtered based on the confidence of the model to retain only the most reliable predictions of the master model.

To this end, in step 703, a confidence score is computed for each object mask as the average of the activations of the attention map of the master model from which the object mask is extracted, at the spatial positions of the map corresponding to the spatial positions of the object mask assuming values of 1.

The confidence score can be represented by the following formula, where c denotes an object mask:

$${score}_{c} = \frac{1}{{\sum }_{j = 1}^{N} c ( j )} {\sum }_{j = 1}^{N} \overline{W} ( j ) ⊙ c ( j ) .$$

In step 704, the object masks c whose confidence score is greater than a predefined threshold s are retained for monitoring the attention maps of the student model; the other objects are deleted. Thus, only the most reliable predictions of the master model are retained. The threshold s assumes a value ranging between 0 and 1, preferably a value close to 1 for effectively filtering the least reliable predictions, for example a value equal to 0.9.

Finally, in step 705, the training of the student attention module ATT_{EL} is monitored by means of a loss function that aims to associate each attention map W₁, . . . W_{K-1} with one of the objects retained after filtering.

For example, a binary cross-entropy loss function is used such as:

$${{L}^{′}}_{BCE} ( c , W ) = - \frac{1}{N} {\sum }_{j = 1}^{N} [ ( 1 + {score}_{c} ) c ( j ) log ( W ( j ) ) + ( 1 - c ( j ) ) log ( 1 - W ( i ) ) ] .$$

The score of the object masks is taken into account in the computation of the loss function so as to grant greater weight to objects with higher confidence.

Thus, each attention map of the master model yields several object masks that are distributed between the attention maps of the student model so that each attention map of the student model specialises in a single object.

An advantage of this monitoring SUP is that it takes into account static objects that are identified in the attention maps of the master model, whereas they are absent from the pseudo-labels PL, which only target mobile objects.

The distribution of each attention map of the master model to several attention maps of the student model avoids a semantic bias that would exist in a more naive configuration where a direct association would be made between a map of the master model and a map of the student model.

In one embodiment of the invention, the attention maps of the student model are monitored by means of a combination of the two loss functions L_{BCE}(m′, W) and L′_{BCE}(c, W), for example the sum of these two functions, optionally weighted by coefficients selected as a function of the respective importance to be granted to monitoring by the master model or to monitoring by the pseudo-labels originating from an external source. The weighting coefficients can be dynamically applied so as to progressively grant more weight to the monitoring carried out by the master model during training. Such an approach enhances the robustness of the student model by mitigating the impact of any errors resulting from external monitoring.

In an alternative embodiment of the invention, the motion information originating from an optical flow sequence can be replaced by or associated with another source of pseudo-labels. For example, the pseudo-labels can be generated by algorithms for discovering objects in images based on the features of pre-trained models, as described in reference [6].

Once the student model has been trained, it can be used for inference on new image data in order to localise objects in the captured scene.

The trained model is executed on an image sequence and outputs an object localisation mask in the scene for each object. The object localisation mask is determined by the attention module via the attention maps. Each attention map corresponds to a separate object. An object localisation mask is obtained, for example, by binarising the activation values of an attention map. In other words, the values of the attention map above an activation threshold are set to 1 in the object localisation mask, while the other values are set to 0.

The invention has several advantages over the techniques of the prior art.

The third embodiment of the invention allows better localisation of static objects by adding a localisation constraint for static objects discovered via the monitoring module SUP, which monitors the student attention module based on the master attention module. Conversely, the object discovery techniques of the prior art that are based on “slot attention” approaches do not limit the model to the discovery of static objects, resulting in limited localisation performance for these static objects.

The third embodiment of the invention also allows localisation of a greater number of objects, notably those that are difficult to capture via the methods of the prior art. Indeed, methods that are solely based on monitoring via pseudo-labels obtained from an external source depend on the quality of these pseudo-labels, which are most often incomplete. The invention allows the monitoring labels to be iteratively completed over the course of training by virtue of the distillation process.

The invention also allows the mobile objects to be better distinguished from noise segments in the pseudo-labels by virtue of an automatic filtering mechanism that specifically targets noise and allows the irrelevant segments in the model outputs to be effectively eliminated.

The methods of the prior art exclusively rely on segments originating from an optical flow sequence for monitoring the model, which has limitations, notably when nearby objects move at the same speed and direction, resulting in fusion errors. Conversely, the third embodiment of the invention uses two monitoring sources (the segments of mobile objects and the predictions of the master model), allowing regularisation (correction) of any errors in the first source by virtue of the predictions of the master model, which, by learning to generalise, becomes more able to withstand these errors. This results in better separation of nearby objects.

The invention can be implemented as a computer program comprising instructions for the execution thereof. The computer program can be stored on a processor-readable storage medium.

The reference to a computer program that, when executed, carries out any one of the previously described functions, is not limited to an application program running on a single host computer. On the contrary, the terms computer program and software are used herein in a general sense to refer to any type of computer code (for example, application software, firmware, microcode, or any other form of computer instruction) that can be used to program one or more processors to implement aspects of the techniques described herein. The computing means or resources can be distributed (“cloud computing”), optionally using peer-to-peer technologies. The software code can be executed on any suitable processor (for example, a microprocessor) or processor core or a set of processors, whether provided in a single computing device or distributed among several computing devices (for example, as is optionally accessible in the environment of the device). The executable code of each program allowing the programmable device to implement the processes according to the invention can be stored, for example, in the hard disk or a read-only memory. In general, the one or more programs can be loaded into one of the storage media of the device before being executed. The central unit can control and direct the execution of the instructions or portions of software code of the one or more programs according to the invention, which instructions are stored in the hard disk or in the read-only memory or even in the other aforementioned storage elements.

The invention can be implemented on a computing device based, for example, on an embedded processor. The processor can be a generic processor, a specific processor, an application-specific integrated circuit (ASIC) or a field-programmable gate array (FPGA). The computing device can use one or more dedicated electronic circuits or a general-purpose circuit. The technique of the invention can be implemented on a reprogrammable computing machine (a processor or a microcontroller, for example) executing a program comprising a sequence of instructions, or on a dedicated computing machine (for example, a set of logic gates, such as an FPGA or an ASIC, or any other hardware module).

### REFERENCES

[1] Bao, Zhipeng et al., “Discovering Objects that Can Move.” 2022 IEEE/CVF Conference on Computer Vision and Pattern Recognition (CVPR) (2022): 11779-11788.
[2] Bao, Zhipeng, et al., “Object Discovery from Motion-Guided Tokens.” Proceedings of the IEEE/CVF Conference on Computer Vision and Pattern Recognition. 2023.
[3] Locatello, Francesco, et al., “Object-centric learning with slot attention.” Advances in Neural Information Processing Systems 33 (2020): 11525-11538.
[4] Kara, Sandra, et al., “The Background Also Matters: Background-Aware Motion-Guided Objects Discovery.” Proceedings of the IEEE/CVF Winter Conference on Applications of Computer Vision. 2024.
[5] Liu, Yen-Cheng, et al., “Unbiased teacher for semi-supervised object detection.” arXiv preprint arXiv:2102.09480 (2021).
[6] Siméoni, Oriane, et al., “Localizing objects with self-supervised transformers and no labels.” arXiv preprint arXiv:2109.14279 (2021).

1. A computer-implemented method for training a machine model (MDO, MDO_{EL}) for discovering objects in an input image sequence (SI), the model comprising:
an encoder (ENC, ENC_{EL}) for encoding each image into a first feature vector;
an attention module (ATT, ATT_{EL}) configured to transform the first feature vector into a plurality of feature vectors, called slots (S₁, . . . S_{K-1}), with the state of a slot being determined from a similarity computation between the first feature vector and each slot in its current state, with each similarity computation defining an attention map (W₁, . . . W_{K-1});
a decoder (DEC) for decoding all the slots in order to reconstruct an image sequence corresponding to the input image sequence (SI);
the learning of the attention maps (W₁, . . . W_{K-1}) being monitored by a set of binary masks for discovering mobile objects produced by an external source, called pseudo-labels (PL), such that each attention map (W₁, . . . W_{K-1}) is activated in a zone corresponding to a distinct object contained in the pseudo-labels (PL), an additional attention map (W_{bg}) is activated in a zone corresponding to the background of the image;
the pseudo-labels (PL) being filtered (FIL) by means of the following steps of: determining an attention map (W_{fg}) of the foreground of the image as being the negative of the additional attention map (W_{bg}), computing a confidence score from the average of the values of the attention map (W_{fg}) of the foreground of the image at the positions of each mobile object present in a pseudo-label, filtering the mobile objects of the pseudo-labels for which the confidence score is below a predefined threshold.

2. The method for training a machine model for discovering objects according to claim 1, wherein the attention map (W_{fg}) of the foreground of the image is determined from the attention map (W_{bg}) of the background of the image of the attention module (ATT, ATT_{EL}) of the model.

3. The method for training a machine model for discovering objects according to claim 1, wherein said model is a student model (MDO_{EL}) at least partially trained via a distillation-based learning transfer mechanism from a master model (MDO_{MA}), with the master model (MDO_{MA}) comprising an encoder (ENC_{MA}) and an attention module (ATT_{MA}), with the attention map (W_{fg}) of the foreground of the image of the student model being determined from the attention map (W_{bg}) of the background of the image of the attention module of the master model.

4. The method for training a machine model for discovering objects according to claim 3, wherein the learning of the attention maps of the student model is monitored by the attention maps of the master model so that each attention map is activated in a zone corresponding to a distinct object discovered in the attention maps of the master model.

5. The method for training a machine model for discovering objects according to claim 4, wherein the learning of the attention maps of the student model comprises the following steps of:
binarising each attention map of the master model;
determining all the connected regions in all the binarised attention maps, with each connected region corresponding to a distinct discovered object.

6. The method for training a machine model for discovering objects according to claim 5, wherein the learning of the attention maps of the student model further comprises the following steps of:
computing a confidence score for each discovered distinct object as being equal to the average value of the activations of said object in each attention map of the master model;
filtering the objects for which the confidence score is below a predetermined threshold.

7. The method for training a machine model for discovering objects according to claim 6, wherein the monitoring of the attention maps of the student model is at least carried out by means of a first cross-entropy loss function applied between the attention maps of the student model and the objects determined from the attention maps of the master model weighted by their confidence score.

8. The method for training a machine model for discovering objects according to claim 1, wherein the monitoring of the attention maps of the model is at least carried out by means of a second cross-entropy loss function applied between the attention maps of the model and the objects of the pseudo-labels weighted by their confidence score.

9. The method for training a machine model for discovering objects according to claim 1, wherein the pseudo-labels are obtained from the image sequence and an associated optical flow sequence.

10. A computer-implemented method for discovering objects in an image sequence comprising the following steps of:
receiving an image sequence;
executing the machine model for discovering objects trained using the method according to claim 1 for the image sequence so as to generate at least one localisation mask for an object in the image sequence, with each localisation mask being obtained from an attention map.

11. A computer program comprising instructions for executing the method according to claim 1, when the program is executed by a processor.

12. A processor-readable storage medium storing a program comprising instructions for executing the method according to claim 1, when the program is executed by a processor.
